(19) United States
(12) Patent Application Publication
(10) Pub. No.: US 2022/0058707 A1
(43) Pub. Date: Feb. 24, 2022

(54) PRODUCT RECOMMENDATION BASED ON MACHINE LEARNING

(71) Applicant: International Business Machines Corporation, Armonk, NY (US)

(72) Inventor: Dayna Herling, Troy, NY (US)

(21) Appl. No.: 17/001,207

(22) Filed: Aug. 24, 2020

(51) Int. Cl. G06Q 30/06; G06N 5/04; G06F 16/951

(52) U.S. Cl. CPC G06Q 30/0617; G06Q 30/0631; G06F 16/951; G06N 5/043

(57) ABSTRACT

An approach for a chatbot to lead a conversation with a customer by autonomously generating a series of questions to derive a recommended product or service is disclosed. The approach includes the chatbot parsing through the website it is deployed on to gather the information it needs to generate relevant questions and provide customers a personalized recommendation in a tree-like diagram, which enables the chatbot to autonomously contrast the products and lead the user throughout the discussion. The customer's needs will be determined by the questions generated for and answered by the potential customer. These identified needs determined by the chatbot's generated questions and responses will be mapped to the recommended solution.

### BACKGROUND

The present invention relates generally to the field of online services, and more particularly, to virtual agents to assist users by leveraging machine learning.

Chatbots are typically used in dialog systems for various practical purposes including customer service or information acquisition. Some chatbots use sophisticated natural language processing systems, but many simpler ones scan for keywords within the input, then pull a reply with the most matching keywords, or the most similar wording pattern, from a database.

Web scraping, web harvesting, or web data extraction is data scraping used for extracting data from websites. Web scraping software may access the internet directly using the HTTP, or through a web browser. While web scraping can be done manually by a software user, the term typically refers to automated processes implemented using a bot or web crawler. It is a form of copying, in which specific data is gathered and copied from the web, typically into a central local database or spreadsheet, for later retrieval or analysis.

### SUMMARY

Embodiments of the present invention disclose a computer-implemented method, computer program product and a computer system for a chatbot to lead a conversation with a customer by autonomously generating a series of questions to derive a recommended product or service. The method may be implemented by one or more computer processors and may include receiving a topic of interest from a customer; deploying a chatbot on a website associated with the topic of interest; web-scraping, by the chatbot, the website for information regarding at least one of products and services associated with the topic of interest, generating, by the chatbot, a series of potential questions and a potential answer to respective questions in the series of potential questions, wherein the series of potential questions and the potential answers to respective questions in the series of questions are based, at least in part, on the topic of interest and the information scraped from the website; transmitting, by the chatbot, a first question in the series of questions to the customer; receiving, by the chatbot, a first answer to the first question from the customer; determining, by the chatbot, a second question from the series of potential questions; transmitting, by the chatbot, the second question to the customer; and recommending, by the chatbot, at least one of a particular product and a particular service to the customer.

The computer program product may include one or more computer readable storage media and program instructions stored on the one or more non-transitory computer readable storage media, the program instructions comprising: program instructions to receive a topic of interest from a customer; program instructions to deploy a chatbot on a website associated with the topic of interest; program instructions to web-scrape, by the chatbot, the website for information regarding at least one of products and services associated with the topic of interest, program instructions to generate, by the chatbot, a series of potential questions and a potential answer to respective questions in the series of potential questions, wherein the series of potential questions and the potential answers to respective questions in the series of questions are based, at least in part, on the topic of interest and the information scraped from the website; program instructions to transmit, by the chatbot, a first question in the series of questions to the customer; program instructions to receive, by the chatbot, a first answer to the first question from the customer; program instructions to determine, by the chatbot, a second question from the series of potential questions; program instructions to transmit, by the chatbot, the second question to the customer; and program instructions to recommend, by the chatbot, at least one of a particular product and a particular service to the customer.

The computer system may include one or more computer processors; one or more computer readable storage media; program instructions stored on the one or more computer readable storage media for execution by at least one of the one or more computer processors, the program instructions comprising: program instructions to receive a topic of interest from a customer; program instructions to deploy a chatbot on a website associated with the topic of interest; program instructions to web-scrape, by the chatbot, the website for information regarding at least one of products and services associated with the topic of interest, program instructions to generate, by the chatbot, a series of potential questions and a potential answer to respective questions in the series of potential questions, wherein the series of potential questions and the potential answers to respective questions in the series of questions are based, at least in part, on the topic of interest and the information scraped from the website; program instructions to transmit, by the chatbot, a first question in the series of questions to the customer; program instructions to receive, by the chatbot, a first answer to the first question from the customer; program instructions to determine, by the chatbot, a second question from the series of potential questions; program instructions to transmit, by the chatbot, the second question to the customer; and program instructions to recommend, by the chatbot, at least one of a particular product and a particular service to the customer.

### BRIEF DESCRIPTION OF THE DRAWINGS

FIG. 1 is a functional block diagram illustrating a topology of a product recommendation environment, designated as 100, in accordance with an embodiment of the present invention;

FIG. 2 is a functional block diagram illustrating chatbot component, in accordance with an embodiment of the present invention;

FIG. 3A is a high-level flowchart illustrating the operation of product recommendation server 110, designated as 300A, in accordance with an embodiment of the present invention;

FIG. 3B is a flowchart illustrating the operation of “run algorithm” 304, in accordance with an embodiment of the present invention;

FIG. 3C is a flowchart illustrating the operation of chatbot component 111, designated as 300C, in accordance with another embodiment of the present invention;

FIG. 4 depicts a block diagram, designated as 400, of components of a server computer capable of executing the chatbot component 111 within the product recommendation server 110, of FIG. 1, in accordance with an embodiment of the present invention;

FIG. 5A, illustrates a full chatbot dialogue flow for a Watson® commerce product;

FIG. 5B, illustrates a continuation, dialogue flow for Digital Experience segment of chatbot, of the full chatbot dialogue flow for a Watson® commerce product from FIG. 5A; and

FIG. 5C, illustrates a continuation, dialogue flow for Order Management segment of chatbot, full chatbot dialogue flow for a Watson® commerce product from FIG. 5B.

### DETAILED DESCRIPTION

Embodiments of the present invention provides an approach to assisting users by recommending products and services offered by a vendor through intelligent Chatbots. For example, when customers look at the product portfolios, it can be difficult to differentiate between the different solutions provided within the portfolio. It is time consuming and frustrating looking through all the information associated with each solution. This is especially true within the categorized solutions, such as when there's multiple solutions listed under “AI,” “Cloud” or even “Asset Management.” Some solutions in each category sound very similar if not identical at first glance. Customers will leave the site out of frustration and that translates to lost sales for the solution provider. Not only is this a challenge externally but also internally. Digital sellers, or sellers who answer customers calls or direct questions about a specific product or problem the customer wants to solve, who must help customers distinguish exactly which product or group of products is right for them, currently have to go through the same time consuming and frustrating process as prospective customers. Digital sellers are sometimes responsible for selling and answering questions across a whole suite of products or company wide solution portfolio, not just about one or two specific products. This is a tremendous amount of knowledge to learn and remember, for both new and experienced digital sellers. Furthermore, most customers don't want to call in and ask a representative about products in the early stages of the buying process. Only 29% of customers prefer to call a representative to learn more about a product, but 62% of people will consult a search engine. Thus, in an embodiment of the present invention, a chatbot can generate leading questions for the user based on web scraped information (e.g., products) from the website of the vendor and the chatbot can lead the conversation towards the desired product.

In an embodiment of the present invention, a chatbot can make it easy and convenient for customers to get a simple recommendation, by asking them relevant and linearly conversational questions about the type of product they are interested in to deduce which product(s) will be right for them. The product or combination of products recommended for the customer will be based on several identified customer needs. The customer needs will be determined by the questions generated for and answered by the potential customer. These identified needs determined by the chatbot's generated questions and responses will be mapped to the recommended solution. Current embodiment can overcome the current limitations associated with existing chatbot technology. Some limitations and/or drawbacks can include the following: i) the drawback of other chatbots, even ones using Natural Language Processing, is that none are made for providing a recommendation based on key differences between multiple services or products, ii) other chatbots are hardcoded for the website it is deployed on or is configured to find information through the company's internal systems and databases. This is a drawback because there's many times when a company provides a choice between multiple (20 or less) different services or products within the same category on their webpages, but there's no system in place to systematically compare and contrast those similar services or products based on their webpages' descriptions and product information. This information is also not all cleansed and stored in a database ready for a chatbot designed to look up information through databases to search. It also can be difficult for a human to read through and remember all the features and requirements of each and properly contrast them all, and iii) no commercially available chatbot is currently built for leading the discussion and contrasting products within the same category on website nor for providing a recommendation which is the main drawback for all other available chatbots towards solving this problem.

In an embodiment of the present invention, a customer is provided access to a search engine through a chatbot specifically for vendor products, or whatever products website it is deployed to, during the initial stages of their search. This is unique from other chatbots because this chatbot is designed to parse through the website it is deployed on to gather the information it needs to generate relevant questions and provide customers a personalized recommendation in a tree-like diagram, which enables the chatbot to autonomously contrast the products and lead the user throughout the discussion. Other chatbots are hardcoded for the specific site it is deployed on or is set up to find information through the company's billing or HR (Human resources) systems and databases.

Some of the advantages of embodiments of the invention includes: i) a chatbot that dynamically and autonomously web scrapes the information it needs when it is deployed on a site, it will not be hardcoded, ii) a chatbot that asks the user questions based off of the web scraped information and compares and contrasts the web scraped information from each of the different products or services to generate the questions, iii) a chatbot that leads the user to a recommended product or service or multiple products or services based on their answers to the questions, and iv) a chatbot that enables the user to find a solution that works for their needs even if they don't know the right questions to ask and what to look for.

A detailed description of embodiments of the claimed structures and methods are disclosed herein; however, it is to be understood that the disclosed embodiments are merely illustrative of the claimed structures and methods that may be embodied in various forms. In addition, each of the examples given in connection with the various embodiments is intended to be illustrative, and not restrictive. Further, the Figures are not necessarily to scale, some features may be exaggerated to show details of particular components. Therefore, specific structural and functional details disclosed herein are not to be interpreted as limiting, but merely as a representative basis for teaching one skilled in the art to variously employ the methods and structures of the present disclosure.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments, whether or not explicitly described.

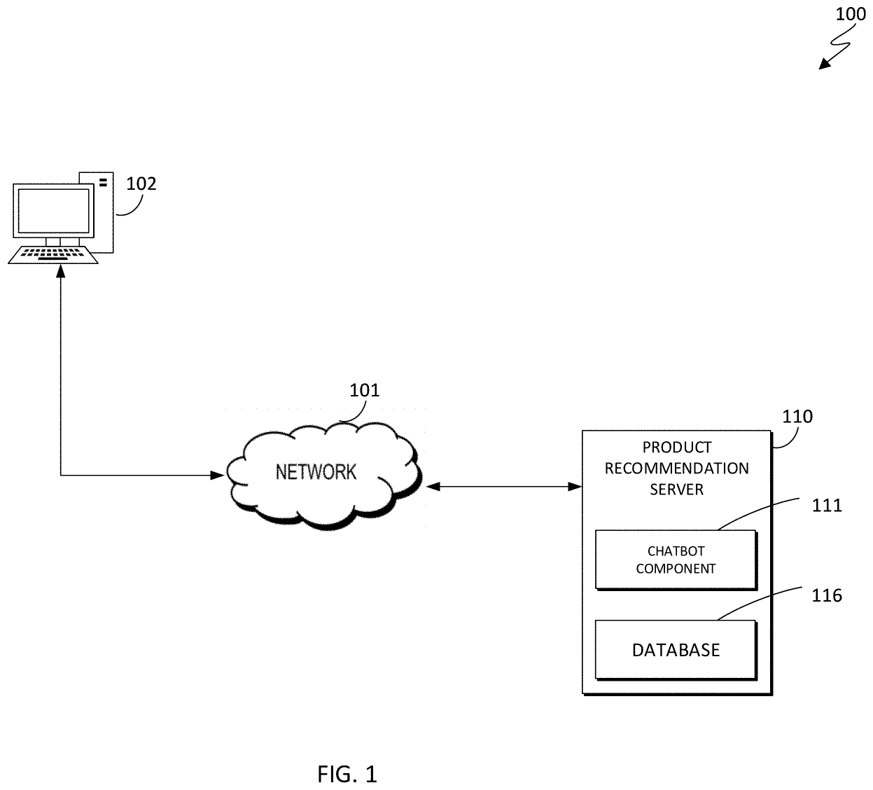

FIG. 1 is a functional block diagram illustrating a topology of a product recommendation server, designated as 100, in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Product recommendation environment 100 includes product network 101, client device 102 and product recommendation server 110.

Network 101 can be, for example, a telecommunications network, a local area network (LAN), a wide area network (WAN), such as the Internet, or a combination of the three, and can include wired, wireless, or fiber optic connections. Network 101 can include one or more wired and/or wireless networks that are capable of receiving and transmitting data, voice, and/or video signals, including multimedia signals that include voice, data, and video information. In general, network 101 can be any combination of connections and protocols that can support communications between product recommendation server 110, client device 102 and other computing devices (not shown) within product recommendation environment 100. It is noted that other computing devices can include, but is not limited to, mobile computing device and any electromechanical devices capable of carrying out a series of computing instructions.

Product recommendation server 110 and client device 102 can be a standalone computing device, a management server, a web server, a mobile computing device, or any other electronic device or computing system capable of receiving, sending, and processing data. In other embodiments, product recommendation server 110 and client device 102 can represent a server computing system utilizing multiple computers as a server system, such as in a cloud computing environment. In another embodiment, product recommendation server 110 and client device 102 can be a laptop computer, a tablet computer, a netbook computer, a personal computer (PC), a desktop computer, a personal digital assistant (PDA), a smart phone, or any other programmable electronic device capable of communicating other computing devices (not shown) within 100 via network 101. In another embodiment, product recommendation server 110 and client device 102 represents a computing system utilizing clustered computers and components (e.g., database server computers, application server computers, etc.) that act as a single pool of seamless resources when accessed within product recommendation environment 100.

Client device 102 can be a website for vendors offering products and/or services to the general consumer.

Product recommendation server 110 includes chatbot component 111 and database 116.

Database 116 is a repository for data used by chatbot component 111. Database 116 can be implemented with any type of storage device capable of storing data and configuration files that can be accessed and utilized by product recommendation server 110, such as a database server, a hard disk drive, or a flash memory. Database 116 uses one or more of a plurality of techniques known in the art to store a plurality of information. In the depicted embodiment, database 116 resides on product recommendation server 110. In another embodiment, database 116 may reside elsewhere within product recommendation environment 100, provided that chatbot component 111 has access to database 116. Database 116 may store information associated with, but is not limited to, products belonging to vendors, category and sub-categories of products, best industry practices, sales information regarding a specific industry, financial information (e.g., annual report, SEC filings, etc.) related to publicly traded and private companies. In an embodiment, database 116 can store information scraped by the chatbot. For example, chatbot is deployed on a web site that contains products or services. The chatbot then scrapes product or service information from the website it is deployed on (in addition to information included in other sources (e.g., information included on other websites, product catalogs, etc.) and stores the information scraped in database 116. Then, chatbot generates questions to lead a conversation with a customer using scraped information to recommend a product or service.

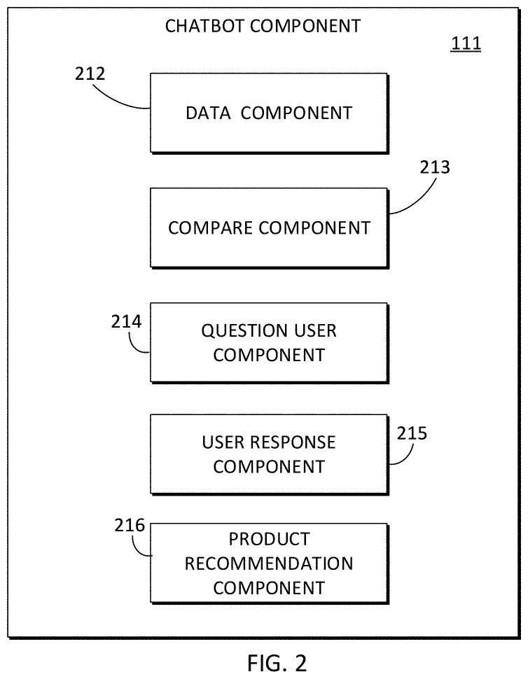

FIG. 2 is a functional block diagram illustrating chatbot component 111 in accordance with an embodiment of the present invention. In the depicted embodiment, chatbot component 111 includes data component 212, compare component 213, question user component 214, user response component 215 and product recommendation component 216.

As is further described herein below, chatbot component 111 of the present invention provides the capability of assisting customers to have a personalized, conversational expert help them distinguish which solution(s) are right for them within vendor's products/services page. This is to improve the digital customer experience and decrease customer churn, resulting in more product sales. Furthermore, internally to the vendor, chatbot component 111 will help new and experienced digital sellers distinguish between key characteristics of vendor's products listed within one category and have a knowledgeable conversation with their clients. Instead of spending hours researching products for customers, digital sellers will use embodiments of the present to increase their productivity and learn faster. The digital sellers will be more inclined to focus on the value the right solution will provide their customers and consequently be more effective, happier sellers.

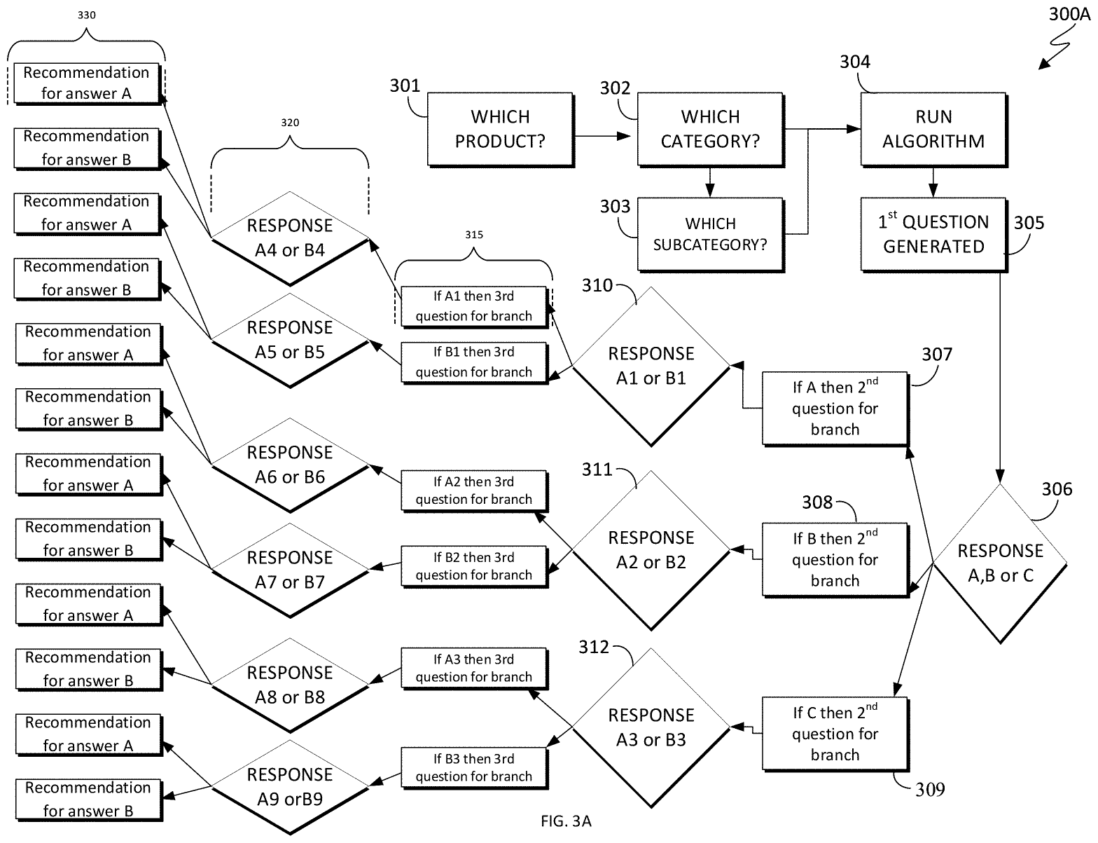

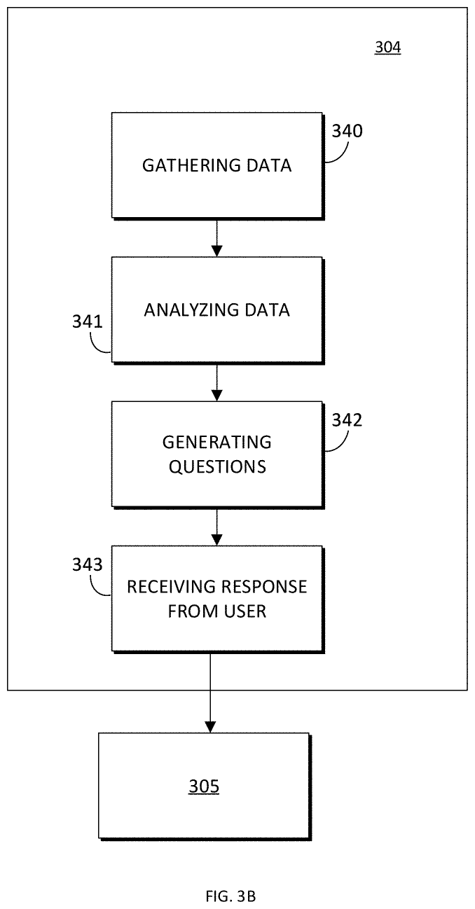

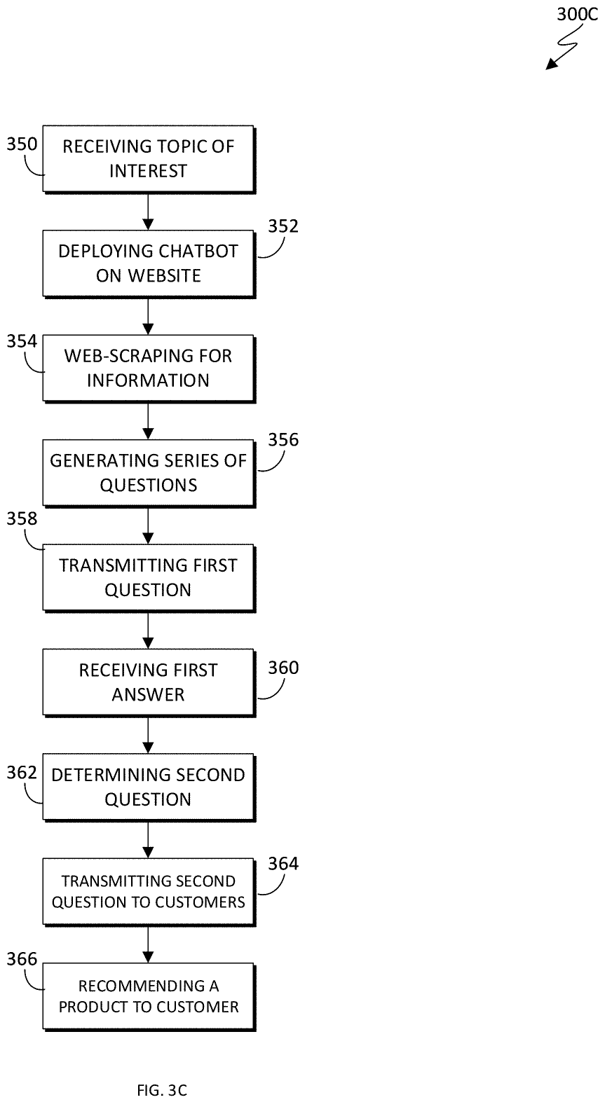

In embodiments of the present invention, the unique capabilities of chatbot component 111 can be summarized as including, but not limited to i) a chatbot that gathers the knowledge needed for guiding the user to a personalized recommendation by web scraping information from the company's products website it is deployed to, ii) a chatbot that generates a tree-like model of the questions (algorithm), possible responses and personalized recommendation(s) by comparing and contrasting the different products within a specific category and/or subcategory on a company's products website (further described in accordance with FIG. 3A below), iii) a chatbot that can compare and contrast the different products via the same information prospective customers see on a company's product webpage, along with the user's answers to questions, to generate additional narrowing questions for the user to answer, iv) a chatbot that employs web scraping to acquire knowledge for generating questions (rather than answering questions) users will answer in determining their personalized recommendation, and v) with complex, technical products, like ones in spaces such as cloud and machine learning, a customer looking for one of these products might not know what types of questions they should be asking to get the right product for their true needs. a chatbot that generates the questions for the user so that the user doesn't need to know what they should be asking to get the right personalized recommendation. This is particularly advantageous in that oftentimes products and/or services are technically complex and a customer looking for a particular product or service may not know what types of questions to ask or which product or service that best fits their needs.

As is further described herein below, data component 212, of the present invention provides the capability of gathering data (e.g., web scraping, etc.) for one or more products (an/or services) offered on a site (e.g., auction, website, etc.) by a vendor/merchant. Any web-scraping technologies such as DOM (Document Object Model) parsing, semi-structured data query languages (e.g., XQuery, HTQL, etc.), vertical specific harvesting platforms and semantic annotation recognizing can be used.

As is further described herein below, compare component 213 of the present invention provides the capability of compare and contrast, by leveraging NLU (Natural Language Understanding) and/or NLP (Natural Language Processing) of machine learning technology, various products offered by the vendor/merchant based on the retrieved data from data component 212.

As is further described herein below, question user component 214, of the present invention provides the capability of generating leading questions for users to answers. However, the questions are generated via reading through the products webpages and determining what the key differences are between the products. It will do this by breaking up the information on each page and identifying the intent of each piece of information using NLU and NLC (Natural Language Classifier) technology. Then the algorithm would compare all the different intents between the different products as to distinguish the key differences. From this information, the questions would be generated that will lead the user to choose between these differences. The question generation would also be done before the chatbot is commercially deployed so that the answers stay consistent per user and can be verified by developers and product specialists for accuracy. However, with each webpage update the questions would be checked for accuracy and regenerated as needed and would be rechecked by the appropriate developer or product specialist. The question generation will be accomplished through programming the chatbot to use of an NLU and/or an NLC to read through the product description on each solutions webpage and determine key differences between each solution within a product category. For example, using IBM's website, of this would be, “What are the key differences between IBM® Content Foundation and IBM® Filenet Content Manager under product category ‘Share and manage enterprise content’” within Automation.

As is further described herein below, user response component 215, of the present invention provides the capability of receiving user responses and inputs and forward those responses to product recommendation component 216. Essentially, user response component 215 provides and manages communication (through user dialogue, emails, etc.) between the user/customers and the product website of the vendor.

As is further described herein below, product recommendation component 216 of the present invention provides the capability of processing those responses (from user response component 215) in order to provide additional questions (via question user component 214) and/or recommend the final product for the user. The chatbot provides a recommendation to a customer via an automatically generated dialogue of questions the user would answer in succession. Since there are a discrete number of products with only a discrete number of possible correct responses and their variations to the questions that will be asked, the possible responses will be programmed directly into the child nodes after the user responds with what category or subcategory of products they are interested in. This will enable the algorithm to build out all the child nodes with questions, possible responses and finally recommendations so it can match the user's input directly with the correct responses instead of doing NLP to process each user response. The chatbot will process the user response to the previous question and would match the response with the possible available responses. From there it asks the question that follows the matched response. It would move forward in the dialog of questions, continuing to get feedback from the user until it has reached the correct recommendation. As such, the recommendations and the questions would be preprogrammed. The recommendations would be preprogrammed from the different and discrete number of products that are available for a specific product category.

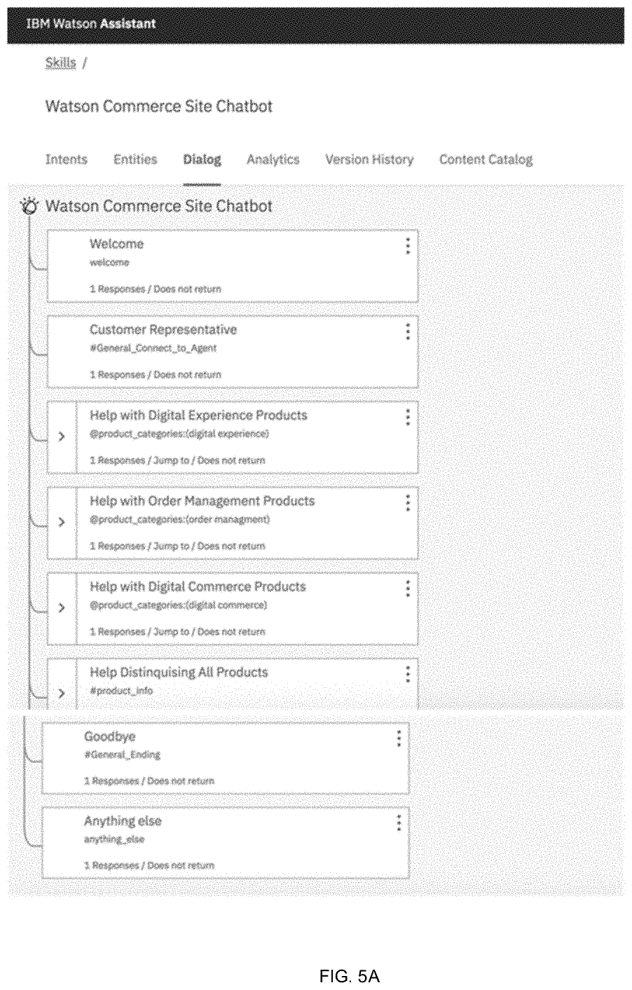

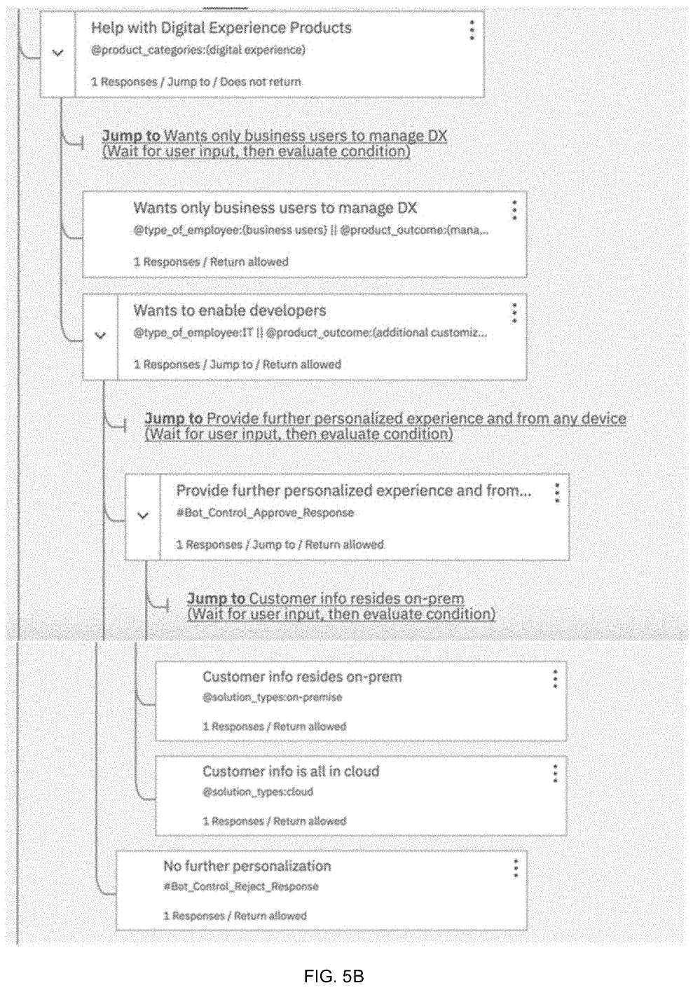

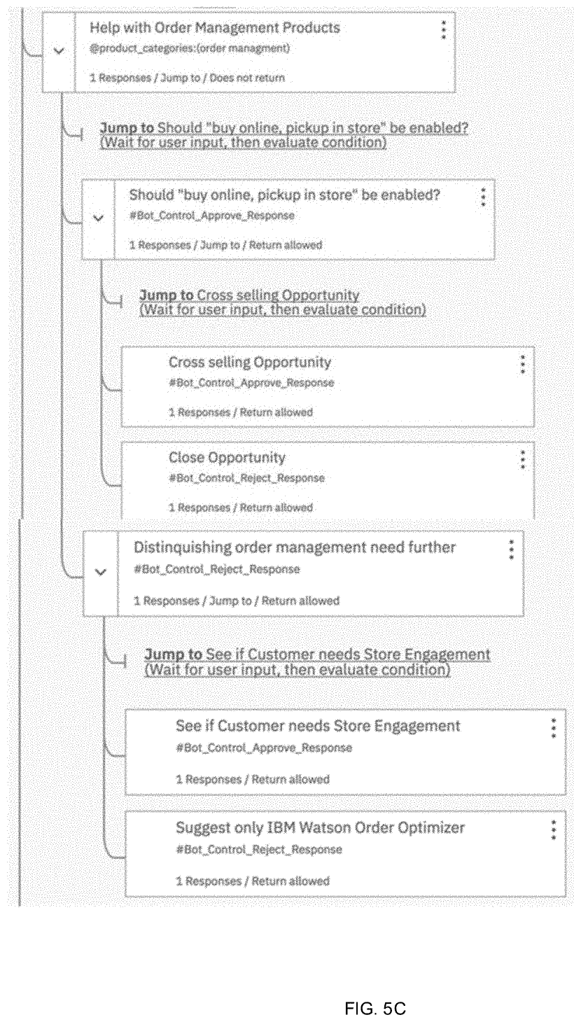

FIG. 3A is a high-level flowchart illustrating a possible operation of product recommendation server 110, designated as 300A, in accordance with an embodiment of the present invention. FIG. 5A, 5B and 5C demonstrates a behind-the-scene process of a possible interaction between the user/consumer with IBM's website, through the use of Watson Assistant (i.e., chatbot dialogue). Other operations of product recommendations server 110 could have m number of questions, n number of responses and x number of recommendations, as will be further explained. The number of questions, responses and recommendations for the present invention is not limited to the number of questions, responses and recommendation explicitly shown in FIG. 3A and could be many more or fewer.

In an embodiment, the process begins with step 301 and continues through steps 304 through 306, where there are decision blocks (e.g., 306, 310, 311, 312, 320 and 330). Furthermore, there are statement blocks (i.e., 315) that follows decision blocks 310, 311 and 312. All six statement blocks at step 315 would be considered a tier of questions and would be the 3^{rd} tier of questions in FIG. 3A. Blocks 307, 308 and 309 together would also be considered a tier of questions and would be the 2^{nd} tier of questions in the example in FIG. 3A. Block 305, even just as one singular question, would be the 1^{st} tier of questions in FIG. 3A.

Step 301 can ask the user, “Which product webpage of Vendor XYZ is the consumer interested in (and possibly list them)?” Block 302 can ask “Which category of product are they interested (and possibly list them)?” Block 303 can ask, “Which subcategory of products are the consumer interested in?” Block 304 is the algorithm that take user inputs and/or responses to generate the first question (block 305). Block 304 will be described in detail in FIG. 3B. Once, the first question is generated (block 305), then embodiment waits for the next response from the consumer (decision block 306). Depending on the response of the consumer (i.e., response A, B or C), embodiment can select block 307, block 308 or block 309. It is noted that the A′s and B′s in the decision blocks just represent one response or a another, not the answering of a question with the same response as for a previous question. For example, the consumer could have used “Response A or B”, “Response C or D”, “Response E or F” or etc. in each decision blocks all the way until the consumer finally answered enough questions where the consumer gets a recommendation. Also, the number of responses in each decision box could be many, let's just say it could have n possible responses, (i.e., n to denote that the amount of possible responses is variable).

It is also further noted that the possible responses predicted from the algorithm would be a category of responses. For example, “Yes” and “Sure” would the same category of response and so the chatbot would consider them to be equivalent responses, meaning they could both be “Response A1” for instance. The same logic would apply for the following responses, “I need a hybrid cloud infrastructure” and “Looking for hybrid cloud environment”.

Then after each possible category of responses, a question would be generated, prompting again a response, which could one of many responses again, and the process would repeat until finally getting to a recommendation. Further noted that the tiers of questions generated would not be limited to 3, again it could be many, or even just two tiers of questions or one. Let's say it could be m possible tiers of questions, (i.e., m to denote that the amount of possible tiers of questions and questions themselves is variable), until a recommendation is reached, which could be any one of x recommendations (i.e., x to denote that the amount of possible recommendations is variable).

Referring back to FIG. 3A, it can be seen that after determining the Vendor XYZ products page and subsequently the category or subcategory the user is interested in, the algorithm in the node will identify all the necessary characteristics for each product. Then, it will populate the remainder of its child nodes with the predicted responses, generated questions and usually after several iterations of this, the recommendation. This recommendation may be one single product or service or a combination of products and/or services. An example is demonstrated in FIGS. 5A, 5B and 5C are one with 3 tiers of questions, 3 responses and a recommendation after each final response. However, that example is shown for simplicity purposes to get the point across. An embodiment of this invention could have m tiers of questions, n responses and x recommendations.

FIG. 3B is a flowchart illustrating the operation of an algorithm (block 304), in accordance with an embodiment of the present invention. For example, block 304 of FIG. 3A can summarize by the following steps: gathering data 340, analyzing data 341, generating questions 342 and receiving response from user 344.

In an embodiment, gathering data 340 can identify all intents and entities (i.e., all product features, the intended main user (business user or developer), type of platform (on-prem system, the cloud or hybrid) and does it work with existing vendor's product offering or another third party.

In an embodiment, analyzing data 341 can generate questions to contrast products per category/subcategory.

In an embodiment, generating questions 342 can populate child node with questions and possible responses.

In an embodiment, generating questions 343 can receive responses from user and populate next question branching for each possible response as to build a tree diagram (any vector or non-vector technique for NLU can be used) and recommend the product based on the branch of the tree diagram ending with a single product or combination of products.

It is noted that for scenarios dealing with multiple inputs and multiple conditional responses can be dealt with another embodiment of the present invention. For example, automating the question generating per each product category can include, but is not limited to, the following: i) built to identify all product features, ii) who is the intended main user (business user or developer), iii) what platform does it function from (on-premise system, the cloud or hybrid cloud) and iv) does it work only with current vendor products or other competitor as well.

Furthermore, the differences between these components identified could then be used to build the minimum number of questions needed to distinguish all of the different products per category or subcategory. Also, the algorithm can identify which products can be used in combination with others in the same category and should ask questions to identify if both the base product and add-on product could be recommended or only the base product.

If there are enough products within the category that the category can be broken into subcategories, these subcategories could be defined by the chatbot itself through contrasting and comparing the products within a category or could be hardcoded into the chatbot. If hardcoded, the chatbot will ask which subcategory of the category the user has already identified that the user is interested in and will specifically list the subcategories names for the user to choose from. It will also be able to handle if the user enters in multiple subcategories and will go through each subcategory's questions and recommendation one by one. The algorithm would be put in each product category's main node and each time a user supplies input that triggers that node in the dialog, the algorithm would run and would generate all the questions needed and would populate all child nodes needed with the questions. It would also generate the predicted responses to a question using entities and intents from an AI (e.g., IBM® Watson Assistant, Google® Assistant, etc.) to identify different types of responses and it would identify different responses that would trigger the same next question or same recommendation if it is the final node before reaching a recommendation. After each predicted response, the next question generated to be asked based on the algorithm ran at the beginning will be put in a child node of the response and this process will repeat until getting a singular or combination of products and/or services as the recommendation.

FIG. 3C is a flowchart illustrating the operation of chatbot component 111, designated as 300C, in accordance with another embodiment of the present invention.

Chatbot component 111 receives a topic of interest (step 350). In an embodiment, chatbot component 111, through data component 212, receives a user/customer input regarding a topic of interest (i.e., product category). For example, CustomerA, works for a consulting company and needs to offer hardware solution to his client. CustomerA may peruse a website for a PC hardware company, ACMEcomputers and clicks on the category of product offered by the company. CustomerA may click on “SERVER” category.

Chatbot component 111 deploys the chatbot (step 352). In an embodiment, chatbot component 111, deploys the chatbot on the website belonging to the vendor.

Chatbot component 111 web-scrapes the website (step 354). In an embodiment, chatbot component 111, through data component 212, gather, by web scraping, product and/or services related information associated with a vendor (i.e., being offered on the website of the vendor).

Chatbot component 111 generating a series of questions and answers (step 356). In an embodiment, chatbot component 111, through compare component 213, question user component 214 and user response component 215, generates a series of questions based on the topic of interest received from the customer (step 350) and information scraped from the website from step 354. Furthermore, chatbot component 111 can generate a series of potential answers to the series of questions. For example, using the previous scenario, the chatbot of ACMEcomputers, may ask “What market does your business operate in?” “What is the size of your client?” and “What solutions are you looking for?” Chatbot component 111 may generate answers such as “Business operates in the offering IT solution to various clients”, “Client size is 100” and “Solutions to help with my client's email problem”, respectively to the series of questions.

Chatbot component 111 transmits the first question (step 358). In an embodiment, chatbot component 111, through question user component 214 transmit the first question from the series of questions to the user. For example, chatbot component 111 can ask the user, “What is the size of your client?”

Chatbot component 111 receiving a first answer (step 360). In an embodiment, chatbot component 111, through user response component 215, receives a response from the user based on the first question. For example, CustomerA may answer, “My client has 200 users with a revenue of less than $10 million dollars.”

Chatbot component 111 determines the second question (step 362). In an embodiment, chatbot component 111, through compare component 213, question user component 214 and user response component 215, pick a second question from the series of questions based on the mapping of the first answer to the first question. For example, using the previous scenario, the chatbot of ACMEcomputers, may ask “What hardware solutions are you looking to help your client?”

Chatbot component 111 transmits the second question (step 364). In an embodiment, chatbot component 111, through question user component 214 transmit the second question from the series of questions to the user. For example, chatbot component 111 can ask the user, “What hardware solutions are you looking to help your client?”

Chatbot component 111 recommends product (step 366). In an embodiment, chatbot component 111, through product recommendation component 216, may recommend products (and/or services) based on the second response (mapped response to the second question) from the customers. For example, based on CustomerA's response to the second question, chatbot component 111 may recommend midrange servers of ACMEcomputers.

In an alternative embodiment, chatbot component 111, compare component 213, question user component 214 and user response component 215, can generate new series of question to ask the customer and series of potential answers. For example, CustomerA is not satisfied with the initial recommendation from chatbot component 111 (i.e., product of midrange servers). Thus, chatbot component 111 may generate follow up questions such as, “What's the primary use of our product and how many users will need to use it?” or “What software application will you be primary hosting and/or using?” and responses such as “Mobile computers for sales force of client”, “Serverless computing—FAAS service” or “Virtual web hosting platform.”

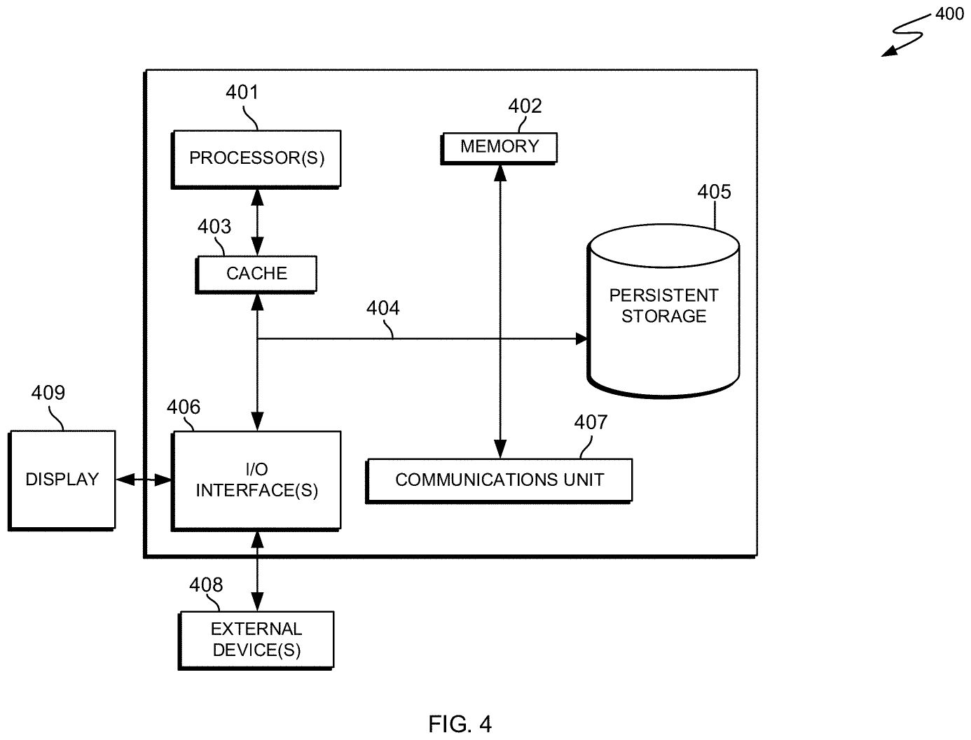

FIG. 4, designated as 400, depicts a block diagram of components of chatbot component 111 application, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

FIG. 4 includes processor(s) 401, cache 403, memory 402, persistent storage 405, communications unit 407, input/output (I/O) interface(s) 406, and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processor(s) 401 by holding recently accessed data, and data near recently accessed data, from memory 402.

Program instructions and data (e.g., software and data ×10) used to practice embodiments of the present invention may be stored in persistent storage 405 and in memory 402 for execution by one or more of the respective processor(s) 401 via cache 403. In an embodiment, persistent storage 405 includes a magnetic hard disk drive. Alternatively, or in addition to a magnetic hard disk drive, persistent storage 405 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405. Chatbot component 111 can be stored in persistent storage 405 for access and/or execution by one or more of the respective processor(s) 401 via cache 403.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data (e.g., Chatbot component 111) used to practice embodiments of the present invention may be downloaded to persistent storage 405 through communications unit 407.

I/O interface(s) 406 allows for input and output of data with other devices that may be connected to each computer system. For example, I/O interface(s) 406 may provide a connection to external device(s) 408, such as a keyboard, a keypad, a touch screen, and/or some other suitable input device. External device(s) 408 can also include portable computer readable storage media, such as, for example, thumb drives, portable optical or magnetic disks, and memory cards. Program instructions and data (e.g., Chatbot component 111) used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor.

FIG. 5A, 5B and 5C illustrate a tree-like branch with various answers/options corresponding to the response from the user (from a programming perspective of a client website). The FIGS. (e.g., 5A, 5B and 5C) only represents a small sample of branches with responses to questions and answers and it is a non-exhaustive list.

FIG. 5A, illustrates a full chatbot dialogue flow for a Watson® commerce product. Any exiting vendor can be used but for illustration purposes, an IBM® product is used in this embodiment. This dialogue flow is built using IBM® Watson Assistant. Watson® Natural Language Understanding and possibly Watson® Natural Language Classifier, or any other natural language understanding or natural language classification tools would be implemented for automating the question generation based on key differences between individual products within the product categories, such as digital experience or order management within Watson® Commerce. Watson® NLU and Watson® NLC could be implemented via the JSON editor. The same chatbot dialogue flow could also be implemented using services from Google®, Amazon®, Microsoft®, or any other company with chatbot, natural language processing and/or AI products, tools or services. For example, in FIG. 5A, there are four options for the user to pick, i) “Help with Digital Experience Products”, ii) “Help with Order Management Products”, iii) “Help with Digital Commerce Products” and iv) “Help with Distinguishing all Products”. It is noted that FIGS. 5A, 5B and 5C are from the perspective of the back-end programing, not from the user/client's perspective.

FIG. 5B, illustrates a continuation, dialogue flow for Digital Experience segment of chatbot, of the full chatbot dialogue flow for a Watson® commerce product from FIG. 5A. Using the previous example from 5A, if the user decided to pick “Help with Digital Experience Products” then two more drop down choice appears (from the user's perspective): i) “Wants only business users to manage DX” and ii) “Wants to enable developers.”

FIG. 5C, illustrates a continuation, dialogue flow for Order Management segment of chatbot, full chatbot dialogue flow for a Watson® commerce product from FIG. 5A. Using the previous example from FIG. 5B, if the user decided to pick “Help with Digital Commerce Products” then two more drop down choice appears (from the user's perspective): i) “IBM® Digital Commerce” and ii) “IBM® WebSphere Commerce.”

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for a chatbot to lead a conversation with a customer by autonomously generating a series of questions to derive a recommended product or service, comprising:
receiving a topic of interest from a customer;
deploying a chatbot on a website associated with the topic of interest;
web-scraping, by the chatbot, the website for information regarding at least one of products and services associated with the topic of interest;
generating, by the chatbot, a series of potential questions and a potential answer to respective questions in the series of potential questions, wherein the series of potential questions and the potential answers to respective questions in the series of questions are based, at least in part, on the topic of interest and the information scraped from the website;
transmitting, by the chatbot, a first question in the series of questions to the customer;
receiving, by the chatbot, a first answer to the first question from the customer;
determining, by the chatbot, a second question from the series of potential questions;
transmitting, by the chatbot, the second question to the customer; and
recommending, by the chatbot, at least one of a particular product and a particular service to the customer.

2. The computer-implemented method of claim 1, wherein generating, by the chatbot, the series of potential questions and the potential answers to the respective questions in the series of potential questions further comprises:
building a first node of one or more nodes of a tree diagram based on the topic of interest and the information scraped from the website, wherein the first node is a root node;
generating the series of potential questions, by leveraging NLC and NLU, based on the topic of interest and the information scraped from the website;
generating the series of potential answers, by leveraging NLC and NLU, based on the generated the series of potential questions; and
mapping the generated series of potential questions and the potential answers to the one or more nodes, wherein the root node is mapped to the first question and the first answer and subsequently series of nodes from the one or more nodes are mapped to remaining of the generated series of potential questions and the series of potential answers, respectively.

3. The computer-implemented method of claim 2, transmitting, by the chatbot, the first question in the series of questions to the customer further comprises:
identifying, by the chatbot, the first question from the series of potential questions based, at least in part, on the topic of interest and the information scraped from the website; and
sending, by the chatbot, the first question in the series of potential questions to the customer.

4. The computer-implemented method of claim 2, wherein determining, by the chatbot, the second question from the series of potential questions is based on the mapped second question associated with the one or more nodes having the first answer to the first question from the series of potential questions.

5. The computer-implemented method of claim 1, wherein recommending, by the chatbot, at least one of a particular product and a particular service to the customer based further comprises:
comparing at least the one of products and services; and
determining the one of the particular products and the particular service to the customer based on the mapped second response to the second question associated with at least one of the particular products and the particular service.

6. The computer-implemented method of claim 1, wherein deploying the chatbot on a website associated with the topic of interest comprises:
building the chatbot, using leveraging machine learning, with the topic of interest and the information scraped from the website; and
installing the chatbot on the website without hardcoding the installation.

7. The computer-implemented method of claim 1, wherein web-scraping, by the chatbot, the website for information further comprises:
extracting data related to the one of products and the services associated with the topic of interest from the website using DOM (Document Object Model) parsing, semi-structured data query languages, vertical specific harvesting platforms and semantic annotation.

8. A computer program product for a chatbot to lead a conversation with a customer by autonomously generating a series of questions to derive a recommended product or service, the computer program product comprising:
one or more non-transitory computer readable storage media and program instructions stored on the one or more non-transitory computer readable storage media, the program instructions comprising:
program instructions to receive a topic of interest from a customer;
program instructions to deploy a chatbot on a website associated with the topic of interest;
program instructions to web-scrape, by the chatbot, the website for information regarding at least one of products and services associated with the topic of interest;
program instructions to generate, by the chatbot, a series of potential questions and a potential answer to respective questions in the series of potential questions, wherein the series of potential questions and the potential answers to respective questions in the series of questions are based, at least in part, on the topic of interest and the information scraped from the website;
program instructions to transmit, by the chatbot, a first question in the series of questions to the customer;
program instructions to receive, by the chatbot, a first answer to the first question from the customer;
program instructions to determine, by the chatbot, a second question from the series of potential questions;
program instructions to transmit, by the chatbot, the second question to the customer; and
program instructions to recommend, by the chatbot, at least one of a particular product and a particular service to the customer.

9. The computer program product of claim 8, wherein program instructions to generate, by the chatbot, the series of potential questions and the potential answers to the respective questions in the series of potential questions further comprises:
program instructions to build a first node of one or more nodes of a tree diagram based on the topic of interest and the information scraped from the website, wherein the first node is a root node;
program instructions to generate the series of potential questions, by leveraging NLC and NLU, based on the topic of interest and the information scraped from the website;
program instructions to generate the series of potential answers, by leveraging NLC and NLU, based on the generated the series of potential questions; and
program instructions to map the generated series of potential questions and the potential answers to the one or more nodes, wherein the root node is mapped to the first question and the first answer and subsequently series of nodes from the one or more nodes are mapped to remaining of the generated series of potential questions and the series of potential answers, respectively.

10. The computer program product of claim 9, program instructions to transmit, by the chatbot, the first question in the series of questions to the customer further comprises:
program instructions to identify, by the chatbot, the first question from the series of potential questions based, at least in part, on the topic of interest and the information scraped from the website; and
program instructions to send, by the chatbot, the first question in the series of potential questions to the customer.

11. The computer program product of claim 9, wherein determining, by the chatbot, the second question from the series of potential questions is based on the mapped second question associated with the one or more nodes having the first answer to the first question from the series of potential questions.

12. The computer program product of claim 8, wherein program instructions to recommend, by the chatbot, at least one of a particular product and a particular service to the customer based further comprises:
program instructions to compare at least the one of products and services; and
program instructions to determine the one of the particular products and the particular service to the customer based on the mapped second response to the second question associated with at least one of the particular products and the particular service.

13. The computer program product of claim 8, wherein program instructions to deploy the chatbot on a website associated with the topic of interest comprises:
program instructions to build the chatbot, using leveraging machine learning, with the topic of interest and the information scraped from the website; and
program instructions to install the chatbot on the website without hardcoding the installation.

14. The computer program product of claim 8, wherein program instructions to web-scrape, by the chatbot, the website for information further comprises:
program instructions to extract data related to the one of products and the services associated with the topic of interest from the website using DOM (Document Object Model) parsing, semi-structured data query languages, vertical specific harvesting platforms and semantic annotation.

15. The computer program product of claim 8, wherein program instructions to recommend, by the chatbot, at least one of a particular product and a particular service to the customer based further comprises:
program instructions to compare at least the one of products and services; and
program instructions to determine the one of the particular products and the particular service to the customer based on the mapped second response to the second question associated with at least one of the particular products and the particular service.

16. A computer system for a chatbot to lead a conversation with a customer by autonomously generating a series of questions to derive a recommended product or service, the computer system comprising:
one or more computer processors;
one or more computer readable storage media; and
program instructions stored on the one or more computer readable storage media for execution by at least one of the one or more computer processors, the program instructions comprising:
program instructions to program instructions to receive a topic of interest from a customer;
program instructions to deploy a chatbot on a website associated with the topic of interest;
program instructions to web-scrape, by the chatbot, the website for information regarding at least one of products and services associated with the topic of interest;
program instructions to generate, by the chatbot, a series of potential questions and a potential answer to respective questions in the series of potential questions, wherein the series of potential questions and the potential answers to respective questions in the series of questions are based, at least in part, on the topic of interest and the information scraped from the website;
program instructions to transmit, by the chatbot, a first question in the series of questions to the customer;
program instructions to receive, by the chatbot, a first answer to the first question from the customer;
program instructions to determine, by the chatbot, a second question from the series of potential questions;
program instructions to transmit, by the chatbot, the second question to the customer; and
program instructions to recommend, by the chatbot, at least one of a particular product and a particular service to the customer.

17. The computer system of claim 16, wherein program instructions to generate, by the chatbot, the series of potential questions and the potential answers to the respective questions in the series of potential questions further comprises:
program instructions to build a first node of one or more nodes of a tree diagram based on the topic of interest and the information scraped from the website, wherein the first node is a root node;
program instructions to generate the series of potential questions, by leveraging NLC and NLU, based on the topic of interest and the information scraped from the website;
program instructions to generate the series of potential answers, by leveraging NLC and NLU, based on the generated the series of potential questions; and
program instructions to map the generated series of potential questions and the potential answers to the one or more nodes, wherein the root node is mapped to the first question and the first answer and subsequently series of nodes from the one or more nodes are mapped to remaining of the generated series of potential questions and the series of potential answers, respectively.

18. The computer system of claim 17, program instructions to transmit, by the chatbot, the first question in the series of questions to the customer further comprises:
program instructions to identify, by the chatbot, the first question from the series of potential questions based, at least in part, on the topic of interest and the information scraped from the website; and
program instructions to send, by the chatbot, the first question in the series of potential questions to the customer.

19. The computer system of claim 17, wherein determining, by the chatbot, the second question from the series of potential questions is based on the mapped second question associated with the one or more nodes having the first answer to the first question from the series of potential questions.

20. The computer system of claim 16, wherein program instructions to deploy the chatbot on a website associated with the topic of interest comprises:
program instructions to build the chatbot, using leveraging machine learning, with the topic of interest and the information scraped from the website; and
program instructions to install the chatbot on the website without hardcoding the installation.
